(19) United States
(12) Patent Application Publication
(10) Pub. No.: US 2020/0404018 A1
(43) Pub. Date: Dec. 24, 2020

(54) METHODS AND SYSTEMS TO DETECT AND COUNTER DENIAL OF SERVICE ATTACK IN VEHICLE COMMUNICATIONS

(71) Applicant: GM GLOBAL TECHNOLOGY OPERATIONS LLC, Detroit, MI (US)

(72) Inventors: Mohammad Naserian, Windsor (CA); Vivek Vijaya Kumar, Shelby Township, MI (US); Hariharan Krishnan, Troy, MI (US); Duane S. Carper, Davison, MI (US)

(73) Assignee: GM GLOBAL TECHNOLOGY OPERATIONS LLC, Detroit, MI (US)

(21) Appl. No.: 16/450,215

(22) Filed: Jun. 24, 2019

(51) Int. Cl. H04L 29/06; H04W 4/40; H04W 4/029; H04K 3/00

(52) U.S. Cl. CPC H04L 63/1458; H04K 3/86; H04W 4/029; H04W 4/40

(57) ABSTRACT

A method for detecting and countering denial of service attacks in V2X communication includes providing a vehicle with a wireless communication system including an antenna and providing a controller in communication with the wireless communication system. The method includes receiving a wireless communication, analyzing the wireless communication and determining if a first condition is satisfied. When the first condition is satisfied, the method includes calculating an angle of arrival of the wireless communication, predicting a location of a source of the wireless communication relative to the vehicle, and adjusting a gain pattern of the antenna to block reception of additional wireless communications from the source of the wireless communication.

### INTRODUCTION

The present disclosure relates generally to detecting and countering denial of service attacks in vehicle-to-everything communications.

Vehicle-to-everything (V2X) communication is the passing of information from a vehicle to any entity that may affect the vehicle, and vice versa. V2X is a vehicular communication system that incorporates other, more specific types of communication such as vehicle-to-infrastructure (V2I), vehicle-to-network (V2N), vehicle-to-vehicle (V2V), vehicle-to-pedestrian (V2P), and vehicle-to-grid (V2G). Denial of service (DOS) attacks are a concern, particularly for connected-vehicle-to-everything, (V2X) communication. DOS attacks could block the transmission and receipt of safety critical messages.

### SUMMARY

Embodiments according to the present disclosure provide a number of advantages. For example, embodiments according to the present disclosure include methods for a host vehicle (HV) to independently detect, identify, and counter V2X communication DOS attacks using a determined angle of arrival of the message.

A method for detecting and countering denial of service attacks in V2X communication, according to an embodiment of the present disclosure, includes providing a vehicle with a wireless communication system including an antenna and providing a controller in communication with the wireless communication system. The method also includes receiving, by the wireless communication system, a wireless communication, analyzing, by the controller, the wireless communication and determining, by the controller, if a first condition is satisfied. When the first condition is satisfied, the method includes calculating, by the controller, an angle of arrival of the wireless communication, predicting, by the controller, a location of a source of the wireless communication relative to the vehicle, and adjusting, by the controller, a gain pattern of the antenna to block reception of additional wireless communications from the source of the wireless communication.

In an exemplary embodiment, the first condition is satisfied when the controller determines that the wireless communication is a denial of service communication and the denial of service communication is impacting receipt of wireless communications by the wireless communication system.

In an exemplary embodiment, adjusting the gain pattern of the antenna includes blocking reception of additional wireless communications from a first area surrounding the vehicle and allowing reception of additional wireless communications from a second area surrounding the vehicle.

In an exemplary embodiment, the first area is an area behind the vehicle and the second area is an area in front of the vehicle.

In an exemplary embodiment, the first area is an area in front of the vehicle and the second area is an area behind the vehicle.

In an exemplary embodiment, the first area is a first partial area of a circle centered on the antenna of the vehicle and the second area is a second partial area of the circle centered on the antenna of the vehicle.

A method for detecting and countering denial of service attacks in V2X communication, according to an embodiment of the present disclosure, includes providing a vehicle with a wireless communication system including an antenna and providing a controller in communication with the wireless communication system. The method includes establishing, by the antenna and the wireless communication system, a communication range area surrounding the vehicle and receiving, by the wireless communication system, a wireless communication. The method also includes analyzing, by the controller, the wireless communication and determining, by the controller if a first condition is satisfied. When the first condition is satisfied, the method includes calculating, by the controller, an angle of arrival of the wireless communication, predicting, by the controller, a location of a source of the wireless communication relative to the vehicle, and adjusting, by the controller, a gain pattern of the antenna to block reception of additional wireless communications from a first area of the communication range area that includes the source of the wireless communication.

In an exemplary embodiment, the first condition is satisfied when the controller determines that the wireless communication is a denial of service communication and the denial of service communication is impacting receipt of wireless communications by the wireless communication system.

In an exemplary embodiment, the method further includes allowing, by the controller, reception of additional wireless communications from a second area of the communication range area that does not include the source of the denial of service.

In an exemplary embodiment, the first area is a first partial area of a circle centered on the antenna of the vehicle and the second area is a second partial area of the circle centered on the antenna of the vehicle.

In an exemplary embodiment, the method further includes continuously updating, by the controller, the location of the source of the denial of service relative to the vehicle.

A system for detecting and countering denial of service attacks in V2X communication, according to an embodiment of the present disclosure, includes a vehicle having a wireless communication system including an antenna and a controller in communication with the wireless communication system. The controller is configured to receive a signal from the wireless communication system, analyze the signal, and determine if a first condition is satisfied. When the first condition is satisfied, the controller is configured to calculate an angle of arrival of the signal, predict a location of a source of the signal relative to the vehicle, and adjust a gain pattern of the antenna to block reception of additional signals from the source of the signal.

In an exemplary embodiment, the first condition is satisfied when the controller determines that the signal is a denial of service and the denial of service is impacting receipt of wireless communications by the wireless communication system of the vehicle.

In an exemplary embodiment, adjusting the gain pattern of the antenna includes blocking reception of additional signals from a first area surrounding the vehicle and allowing reception of additional signals from a second area surrounding the vehicle.

In an exemplary embodiment, the first area is an area behind the vehicle and the second area is an area in front of the vehicle.

In an exemplary embodiment, the first area is an area in front of the vehicle and the second area is an area behind the vehicle.

In an exemplary embodiment, the first area is a first partial area of a circle centered on the antenna of the vehicle and the second area is a second partial area of the circle centered on the antenna of the vehicle.

In an exemplary embodiment, the antenna of the wireless communication system of the vehicle generates a communication range area, the source of the signal is within the communication range area, and adjusting the gain pattern of the antenna includes blocking reception of additional signals from a first area of the communication range area and allowing reception of additional signals from a second area of the communication range area.

In an exemplary embodiment, the first area is a first partial area of a circle centered on the antenna of the vehicle and the second area is a second partial area of the circle centered on the antenna of the vehicle.

In an exemplary embodiment, the first area is an area extending from a first end of the vehicle and the second area is an area extending from a second end of the vehicle opposite the first end of the vehicle.

### BRIEF DESCRIPTION OF THE DRAWINGS

The present disclosure will be described in conjunction with the following figures, wherein like numerals denote like elements.

FIG. 1 is a schematic diagram of a vehicle, according to an embodiment of the present disclosure.

FIG. 2 is a schematic diagram of a V2X communication between a host vehicle and a transmitting vehicle, according to an embodiment of the present disclosure.

FIG. 3 is a schematic diagram of a V2X communication between a host vehicle and a transmitting vehicle in which a denial of service attack is countered, according to an embodiment of the present disclosure.

FIG. 4 is a schematic diagram of a V2X communication between a host vehicle and a transmitting vehicle, according to an embodiment of the present disclosure.

FIG. 5 is a schematic diagram of a V2X communication between a host vehicle and a transmitting vehicle in which a denial of service attack is countered, according to an embodiment of the present disclosure.

FIG. 6 is a flowchart representation of a method of controlling a vehicle, according to an embodiment of the present disclosure.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

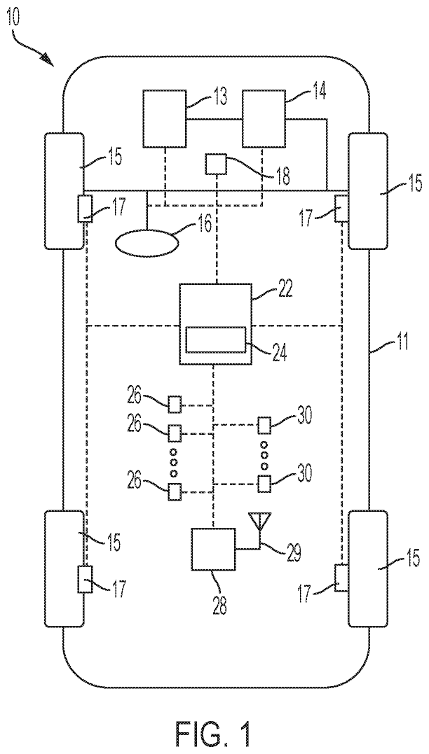

FIG. 1 schematically illustrates an automotive vehicle 10 according to the present disclosure. The vehicle 10 is depicted in the illustrated embodiment as a passenger car, but it should be appreciated that any other vehicle, including motorcycles, trucks,, sport utility vehicles (SUVs), or recreational vehicles (RVs), etc., can also be used. The vehicle 10 includes a propulsion system 13, which may in various embodiments include an internal combustion engine, an electric machine such as a traction motor, and/or a fuel cell propulsion system.

The vehicle 10 generally includes a body 11 and wheels 15. The body 11 encloses the other components of the vehicle 10 and also defines a passenger compartment. The wheels 15 are each rotationally coupled to the body 11 near a respective corner of the body 11.

The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously variable transmission, or other appropriate transmission.

The vehicle 10 additionally includes a steering system 16. While depicted as including a steering wheel for illustrative purposes, in some embodiments contemplated within the scope of the present disclosure, the steering system 16 may not include a steering wheel.

The vehicle 10 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

In various embodiments, the vehicle 10 also includes a wireless communication system 28 configured to wirelessly communicate with any wireless communication equipped device (vehicle-to-everything or “V2X”), including other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 and cellular data communication, are also considered within the scope of the present disclosure. Additionally, wireless communication systems configured to communicate with traffic lights, cellular towers or relays, etc. using LTE, 5G, and other communication standards, are also considered within the scope of the present disclosure. In various embodiments, the wireless communication system 28 includes one or more antennas 29 configured to receive and transmit wireless communication signals. In various embodiments, the one or more antennas are directional antennas.

The propulsion system 13, transmission 14, steering system 16, and wireless communication system 28 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

In various embodiments, the controller 22 includes a communication analysis system 24 for receiving and analyzing signals and messages received via the wireless communication system 28. The communication analysis system 24 detects and identifies the various signals and messages received from the wireless communication system 28 to counter a denial of service message as discussed herein.

In various embodiments, the controller 22 is configured to automatically control the propulsion system 13, transmission 14, steering system 16, and wheel brakes 17 via one or more brake control modules to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

Faulty, or misbehaving, V2X modules can transmit a flood of signals, in a denial of service attack, that can make the receiving machine or network resource unavailable to its intended users or unable to receive critical messages by temporarily or indefinitely disrupting the services of the host. The flood of signals can overload the host system and prevent some or all legitimate requests or messages from being received or fulfilled. The embodiments discussed herein use the antenna(s) associated with a wireless communication system of the host vehicle to identify and detect denial of service messages.

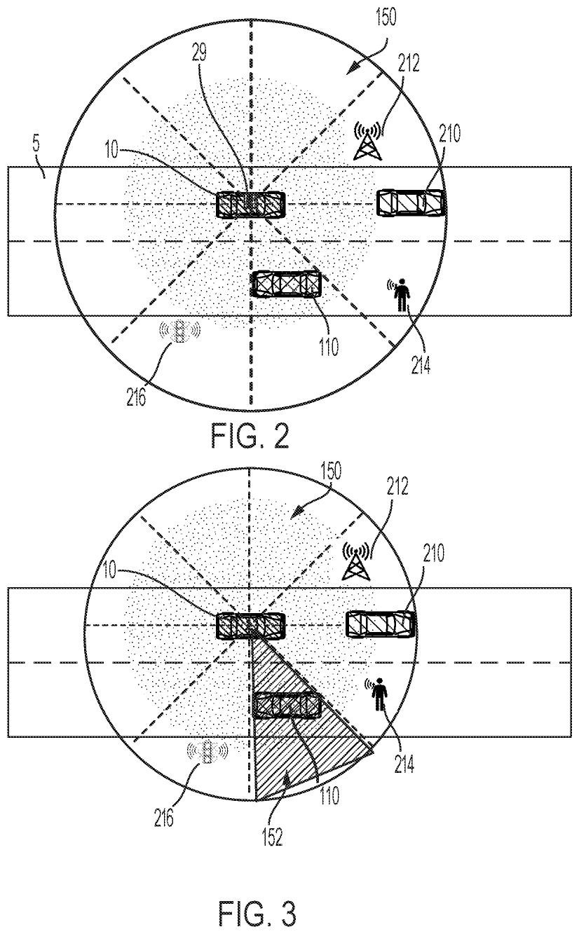

FIGS. 2 and 3 are schematic illustrations of a host vehicle, such as the vehicle 10, receiving communication via the antenna(s) 29 of the wireless communication system 28 within a communication range area 150, according to an embodiment of the present disclosure. The host vehicle 10 is shown traveling along a roadway 5, but it is understood that the host vehicle 10 may be stationary and the wireless communication system 28 can still receive and identify V2X communication.

The host vehicle 10 includes an antenna, such as the antenna 29, configured to receive wireless communications within the communication range area 150. In various embodiments, the antenna 29 includes multiple directional elements. In various embodiments, as shown in FIG. 2, the communication range area 150 may be divided into multiple partitions or “slices”. Using angle of arrival measurements, the controller 22 of the host vehicle 10 can determine the direction of propagation of a signal from a transmitting vehicle, identify whether the signal is a denial of service signal, and modify or block reception of messages from the partition of the communication range area 150 from which the signal originates.

As shown in FIG. 2, a transmitting vehicle 110 passes through or within range of the communication range area 150. The transmitting vehicle 110 also includes a wireless communication system 28. The transmitting vehicle 110 transmits a signal that is received by the host vehicle 10. The controller 22 of the host vehicle 10 receives the signal from the wireless communication system 28 of the host vehicle 10 and identifies the signal as a denial of service attack. The controller 22 uses the data gathered by the antenna(s) 29 of the host vehicle 10 to determine the angle of arrival of the wireless message to identify the location of the transmitting vehicle 110 relative to the host vehicle 10. In various embodiments, the transmitting vehicle 110 is moving or stationary or is anywhere within the wireless proximity range defined by the communication range area 150 of the host vehicle 10.

FIG. 2 also illustrates a cellular communication tower 212, a pedestrian 214 with a communication transmitter, and a traffic light 216. Each of the tower 212, the pedestrian 214, and the traffic light 216 may transmit wireless communications that can be received by the host vehicle 10 and are possible sources of a denial of service attack as the communication range area 150 encompasses each of these sources as the host vehicle 10 travels along the roadway 5. In various embodiments, the denial of service attack from the transmitting vehicle 110 targets communication between the host vehicle 10 and any one or more of the tower 212, the pedestrian 214, and the traffic light 216.

The controller 22 of the host vehicle 10 uses the data generated on the location of the transmitting vehicle 110 to modify the antenna pattern of the antenna(s) 29 of the host vehicle 10 to block and/or ignore wireless messages from the transmitting vehicle 110. In various embodiments, the controller 22 can block reception of messages or signals received from a specific partition or slice of the communication range area 150, as shown by the blocked area 152, by adjusting the antenna pattern of the antenna(s) 29 of the host vehicle 10. The blocked area 152 encompasses the identified location of the transmitting vehicle 110 that is transmitting the denial of service message. In various embodiments, the controller 22 updates or generates a revocation list that includes the location and identity of the misbehaving transmitting vehicle 110.

The host vehicle 10 continues to receive messages from the other areas within the communication range area 150, including receiving messages from the transmitting vehicle 210, the tower 212, the pedestrian 214, and the traffic light 216, any of which may enter the communication range area 150 as the host vehicle 10 travels along the roadway 5. The controller 22 continuously receives data from the antenna(s) 29, identifies the signal data, updates the angle of arrival of wireless messages, and updates the location of any transmitting vehicle 110 determined to be transmitting denial of service messages.

The embodiment shown in FIGS. 2 and 3 is a targeted approach that minimizes the number of communication sources with which communication with the host vehicle 10 is affected.

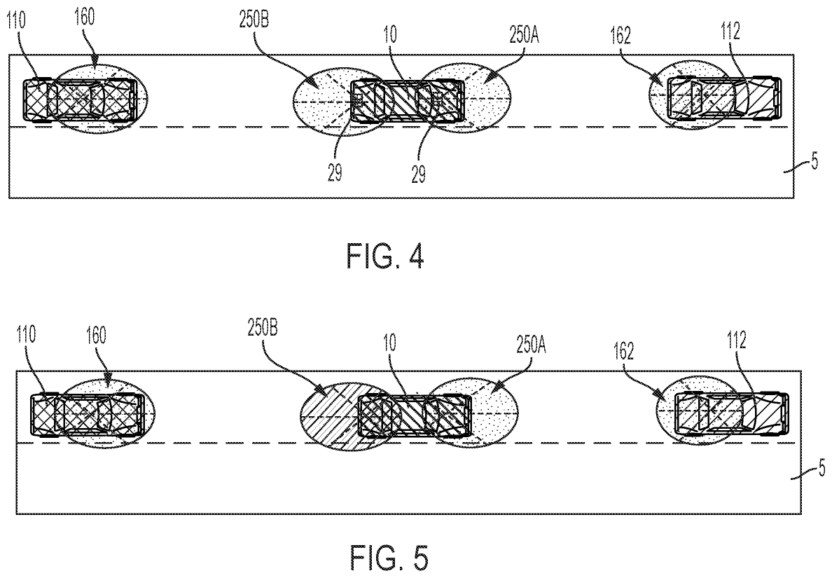

FIGS. 4 and 5 are schematic illustrations of a host vehicle, such as the vehicle 10, receiving communication via the wireless communication system 28 within communication range areas 250A, 250B, according to an embodiment of the present disclosure. The host vehicle 10 is shown traveling along a roadway 5, but it is understood that the wireless communication system 28 of the host vehicle 10 may be stationary and still receive and identify V2X communication.

The host vehicle 10 includes two antennas 29. A first or forward antenna 29 is located in the front of the host vehicle 10 and a second or rearward antenna 29 is located at the rear of the host vehicle 10. The first antenna 29 is configured to receive wireless communications within the communication range area 250A directed forward of the host vehicle 10. The second antenna 29 is configured to receive wireless communications within the communication range area 250B directed rearward of the host vehicle 10. In various embodiments, the host vehicle 10 has a longer communication range forward and rearward of the vehicle, as shown by the communication range areas 250A, 250B.

The forward and rearward antennas 29 allow the host vehicle 10 to receive wireless communications from vehicles both in front of and behind the vehicle, as illustrated by the transmitting vehicles 110 and 112. Each of the transmitting vehicles 110, 112 also include at least one antenna (not shown). The antenna of the transmitting vehicle 110 has a communication range area 160 and the antenna of the transmitting vehicle 112 has a communication range area 162.

In various embodiments, as shown in FIG. 5, using angle of arrival measurements, the controller 22 of the host vehicle 10 can determine the direction of propagation of a signal from a transmitting vehicle and modify or block reception of messages from the direction from which the signal originates.

As shown in FIG. 5, the transmitting vehicle 110 transmits a signal that is received by the host vehicle 10. The controller 22 of the host vehicle 10 identifies the signal as a denial of service attack. The controller 22 uses the data gathered by the first and second antennas 29 of the host vehicle 10 to determine the angle of arrival of the wireless message to identify the location of the transmitting vehicle 110 relative to the host vehicle 10.

With reference to the exemplary embodiment shown in FIG. 5, the controller 22 of the host vehicle 10 uses the data generated on the location of the transmitting vehicle 110 to identify that the transmitting vehicle 110 located behind the host vehicle 10 is generating and transmitting denial of service communications. The controller 22 controls the wireless communication system 28 to disable the second or rearward antenna 29 of the host vehicle 10 to block and/or ignore wireless messages from the transmitting vehicle 110. In various embodiments, the controller 22 can block reception of messages or signals received by one of the antennas 29 while continuing to receive communication via the other antenna 29. As shown in FIG. 5, the controller 22 blocks reception of signals from the rearward transmitting vehicle 110 by disabling the rearward antenna 29 but continues to receive communication from the transmitting vehicle 210 in front of the host vehicle 10 via the forward antenna 29. In various embodiments, the controller 22 updates or generates a revocation list that includes the location and identity of the misbehaving transmitting vehicle 110.

The host vehicle 10 continues to receive messages from the unblocked communication range area 250A, including from the transmitting vehicle 210, which may enter the communication range area 250A as the host vehicle 10 travels along the roadway 5. The controller 22 continuously receives data from the antenna(s) 29, identifies the signal data, updates the angle of arrival of wireless messages, and updates the location of any transmitting vehicle 110, 112 determined to be transmitting denial of service messages. Changes in the relative location of the vehicle determined to be the source of denial of service messages to the host vehicle 10 are continuously determined by the controller 22 and used to update the antenna pattern of the antenna(s) 29.

Throughout FIGS. 2, 3, 4, and 5, the communication range area 150, communication range area 250A, and communication range area 250B are not illustrated to scale. In various embodiments, the sizes of the communication range areas 150, 160, 162, 250A, 250B depend on various environmental conditions and equipment specifications, including, for example and without limitation, the size and power of the antenna(s) 29. Furthermore, the tower 212, the pedestrian 214, and the traffic light 216, as well as the vehicle 10, and the transmitting vehicles 110, 210 are also not depicted to scale in the figures.

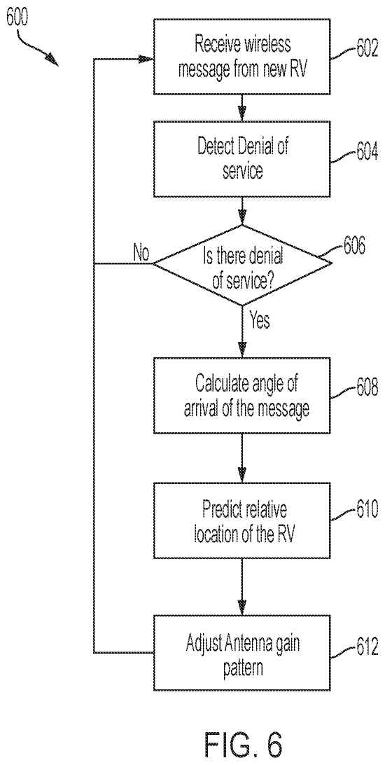

FIG. 6 is a flowchart representation of a method 600 of controlling a vehicle, according to an embodiment of the present disclosure. The method 600 can be utilized in connection with the vehicle 10 shown in FIG. 1 and with the controller 22 as discussed herein, or by other systems associated with or separate from the vehicle, in accordance with exemplary embodiments. The order of operation of the method 600 is not limited to the sequential execution as illustrated in FIG. 6, but may be performed in one or more varying orders, or steps may be performed simultaneously, as applicable in accordance with the present disclosure.

Beginning at 602, the wireless communication system 28 of the host vehicle, such as the host vehicle 10, receives a wireless communication from a transmitting vehicle within a wireless communication range area of the host vehicle 10. The antenna 29 establishes the wireless communication range area surrounding the host vehicle 10. Next, at 604, the controller 22 analyzes the wireless communication to determine the nature of the communication, that is, if a denial of service communication has been received by the host vehicle 10.

At 606, the controller 22 determines whether a first condition is satisfied, that is, that the denial of service communication is impacting the receipt of wireless communication by the wireless communication system 28, such as in a denial of service attack. If the controller 22 determines that the first condition is not satisfied, that is, that wireless communication is not affected by the signals received from the transmitting vehicle, the method 600 returns to 602 and proceeds as discussed herein.

If the controller 22 determines that the first condition is satisfied and wireless communications are being affected by the signals received from the transmitting vehicle, the method 600 proceeds to 608. At 608, the controller 22 calculates the angle of arrival of the message or signal received by the wireless communication system 28 from the transmitting vehicle. Next, at 610, the controller 22 predicts the relative location of the transmitting vehicle from the angle of arrival of the signal. Once the relative location of the source of the denial of service signal is determined, the controller 22, at 612, adjusts the gain pattern of the antenna 29 to block reception of the signals originating from the transmitting vehicle while maintaining reception of signals from other vehicles, infrastructure, or other wireless communication sources in range of the wireless communication system 28 of the host vehicle 10. In various embodiments, the controller 22 blocks reception of signals from a specified area in the environment surrounding the host vehicle 10. In various embodiments, the controller 22 adds the location or identification of the transmitting vehicle to a revocation list and continuously updates the revocation list based on the updated predicted location of the transmitting vehicle.

From 612, in various embodiments, the method 600 repeats continuously.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered. herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives and is not intended to limit the selection to only those listed alternatives or to only one of the listed alternatives at a time, unless the context dearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for detecting and countering denial of service attacks in V2X communication, comprising:
providing a vehicle with a wireless communication system including an antenna;
providing a controller in communication with the wireless communication system;
receiving, by the wireless communication system, a wireless communication;
analyzing, by the controller, the wireless communication and determining, by the controller, if a first condition is satisfied;
in response to determining that the first condition is satisfied, calculating, by the controller, an angle of arrival of the wireless communication;
predicting, by the controller, a location of a source of the wireless communication relative to the vehicle; and
adjusting, by the controller, a gain pattern of the antenna to block reception of additional wireless communications from the source of the wireless communication.

2. The method of claim 1, wherein the first condition is satisfied when the controller determines that the wireless communication is a denial of service communication and the denial of service communication is impacting receipt of wireless communications by the wireless communication system.

3. The method of claim 1, wherein adjusting the gain pattern of the antenna includes blocking reception of additional wireless communications from a first area surrounding the vehicle and allowing reception of additional wireless communications from a second area surrounding the vehicle.

4. The method of claim 3, wherein the first area is an area behind the vehicle and the second area is an area in front of the vehicle.

5. The method of claim 3, wherein the first area is an area in front of the vehicle and the second area is an area behind the vehicle.

6. The method of claim 3, wherein the first area is a first partial area of a circle centered on the antenna of the vehicle and the second area is a second partial area of the circle centered on the antenna of the vehicle.

7. A method for detecting and countering denial of service attacks in V2X communication, comprising:
providing a vehicle with a wireless communication system including an antenna;
providing a controller in communication with the wireless communication system;
establishing, by the antenna and the wireless communication system, a communication range area surrounding the vehicle;
receiving, by the wireless communication system, a wireless communication;
analyzing, by the controller, the wireless communication and determining, by the controller if a first condition is satisfied;
in response to determining that the first condition is satisfied, calculating, by the controller, an angle of arrival of the wireless communication;
predicting, by the controller, a location of a source of the wireless communication relative to the vehicle; and
adjusting, by the controller, a gain pattern of the antenna to block reception of additional wireless communications from a first area of the communication range area that includes the source of the wireless communication.

8. The method of claim 7, wherein the first condition is satisfied when the controller determines that the wireless communication is a denial of service communication and the denial of service communication is impacting receipt of wireless communications by the wireless communication system.

9. The method of claim 8 further comprising allowing, by the controller, reception of additional wireless communications from a second area of the communication range area that does not include the source of the denial of service.

10. The method of claim 9, wherein the first area is a first partial area of a circle centered on the antenna of the vehicle and the second area is a second partial area of the circle centered on the antenna of the vehicle.

11. The method of claim 8 further comprising continuously updating, by the controller, the location of the source of the denial of service relative to the vehicle.

12. A system for detecting and countering denial of service attacks in V2X communication, comprising:
a vehicle having a wireless communication system including an antenna and a controller in communication with the wireless communication system, the controller configured to receive a signal from the wireless communication system;
analyze the signal and determine if a first condition is satisfied;
in response to determining that the first condition is satisfied, calculate an angle of arrival of the signal;
predict a location of a source of the signal relative to the vehicle; and
adjust a gain pattern of the antenna to block reception of additional signals from the source of the signal.

13. The system of claim 12, wherein the first condition is satisfied when the controller determines that the signal is a denial of service and the denial of service is impacting receipt of wireless communications by the wireless communication system of the vehicle.

14. The system of claim 12, wherein adjusting the gain pattern of the antenna includes blocking reception of additional signals from a first area surrounding the vehicle and allowing reception of additional signals from a second area surrounding the vehicle.

15. The system of claim 14, wherein the first area is an area behind the vehicle and the second area is an area in front of the vehicle.

16. The system of claim 14, wherein the first area is an area in front of the vehicle and the second area is an area behind the vehicle.

17. The system of claim 14, wherein the first area is a first partial area of a circle centered on the antenna of the vehicle and the second area is a second partial area of the circle centered on the antenna of the vehicle.

18. The system of claim 12, wherein the antenna of the wireless communication system of the vehicle generates a communication range area, the source of the signal is within the communication range area, and adjusting the gain pattern of the antenna includes blocking reception of additional signals from a first area of the communication range area and allowing reception of additional signals from a second area of the communication range area.

19. The system of claim 18, wherein the first area is a first partial area of a circle centered on the antenna of the vehicle and the second area is a second partial area of the circle centered on the antenna of the vehicle.

20. The system of claim 18, wherein the first area is an area extending from a first end of the vehicle and the second area is an area extending from a second end of the vehicle opposite the first end of the vehicle.
